(19) United States
(12) Patent Application Publication
(10) Pub. No.: US 2014/0081608 A1
(43) Pub. Date: Mar. 20, 2014

(54) METHOD FOR WEAPON SYSTEM-TARGET PAIRING IN REAL-TIME

(71) Applicant: NETWORK ASSIGNMENTS, LLC, (US)

(72) Inventor: Connor McLemore, Uruma-City (JP)

(73) Assignee: NETWORK ASSIGNMENTS, LLC, Poway, CA (US)

(21) Appl. No.: 13/784,764

(22) Filed: Mar. 4, 2013

Related U.S. Application Data
(60) Provisional application No. 61/700,943, filed on Sep. 14, 2012.

(51) Int. Cl. G06F 17/50

(52) U.S. Cl. CPC G06F 17/5009
USPC 703/2

(57) ABSTRACT

Disclosed herein is an automated method for real-time pairing of weapon systems with targets. Databases are populated with inputs which include available weapon systems, targets, and threats. These inputs are entered into a table and the inputs in the table are pre-processed to create formatted data. An optimization engine is executed which analyses the model formulation, selects an algorithm then runs the algorithm. The optimization engine solution is processed into recommended weapon system-target pairings. These recommended weapon system-target pairings are received from the engine then displayed on a user interface. The populating, entering, pre-processing, running, receiving, and displaying are performed in real-time.

### CROSS REFERENCE TO RELATED APPLICATIONS

This application claims priority benefit to U.S. Provisional Application No. 61/700,943, entitled “Method for Weapon System-Target Pairing in Real-time” filed Sep. 14, 2012, which is incorporated by reference in its entirety herein as if it was put forth in full below.

### BACKGROUND

Battle management systems, specifically, weapon system-target pairings, are currently available. For example, when a weapon system is required for use against a target, the desired result is rapid arrival/targeting of appropriate weapon systems to interact with the target. However, current known systems focus mainly on the non-real time planning process where slow, i.e., measured in minutes, hours, or even days, system run times may be adequate. Many systems typically require the operator to pair the weapons to targets manually.

A currently available system uses a genetic algorithm to solve its mathematical model with a transition objective to generate multiple weapon system-target pairing options, with a system run time of less than 4 minutes for twenty weapon system-target pairs.

### SUMMARY

Disclosed herein is an automated method for real-time pairing of weapon systems with targets. Databases are populated with inputs which include available weapon systems, targets, and threats. These inputs are entered into a table and the inputs in the table are pre-processed to create formatted data. An optimization engine is executed which analyses the model formulation, selects an algorithm then runs the algorithm. The optimization engine solution is processed into recommended weapon system-target pairings. These recommended weapon system-target pairings are received from the optimization engine then displayed on a user interface. The populating, entering, pre-processing, running, receiving, and displaying are performed in real-time.

The present invention is better understood upon consideration of the detailed description below in conjunction with the accompanying drawings and claims.

### BRIEF DESCRIPTION OF DRAWINGS

FIG. 1 is a flowchart for an embodiment of the present invention;

FIG. 2 depicts an embodiment of the present invention;

FIG. 3 illustrates an example of a weapon system table;

FIG. 4 describes an example target table;

FIG. 5 discloses an example threats table;

FIG. 6 is an example weapon table;

FIG. 7 illustrates an example table for recommended weapon system-target pairings; and

FIG. 8 details an example table for accepted weapon system-target pairings.

### DETAILED DESCRIPTION

Disclosed herein is an automated method for real-time pairing of weapon systems with targets. Databases are populated with inputs which include available weapon systems, targets, and threats. These inputs are entered into a table and the inputs in the table are pre-processed to create formatted data. An optimization engine is executed which analyses the model formulation, selects an algorithm then runs the algorithm. For example, a model formulated as an integer linear program could be solved by a simplex or interior point algorithm, to solve the chosen mathematical model using the formatted data. The optimization engine solution is processed into recommended weapon system-target pairings. These recommended weapon system-target pairings are received from the optimization engine then displayed on a user interface. The populating, entering, pre-processing, running, receiving, and displaying are performed in real-time.

Real-time as defined in this application is significantly less than 3 minutes, for example a time period less than 1 minute, less than 30 seconds, or less than 10 seconds. In one embodiment described herein, the populating, entering, pre-processing, running, receiving, and displaying are completed in real-time and capable of occurring in less than 1 second. The real-time speed is dependent on the size of the data set. For example, for a twenty weapon system pairing, the program provides outputs in about 1 second, for a 100×100 system, 10 seconds, and for a 300×300 system, a few minutes. The inputs may be provided by a user and each weapon has specific probabilities of success.

Furthermore, a user may accept or reject the weapon system-target pairing recommendations which are updated based on the user input for accepted and rejected recommended pairings and displayed on the user interface in order from a pairing with highest reward value to a pairing with the lowest reward value. The database is arranged in a table, chart or graph format and displayed in order of available weapons, targets, and threats in separate formats and may be linked to another table, chart or graph. The populating and accessing of the database on a device may be accomplished by drop down menus or by pre-populated drop down menus. The devices may be linked via a satellite, internet, optical fiber, or radio (including cellular) network transmitting data through an internet service provider (ISP), data link, or voice format.

The present invention allows operators to manage large-scale combat operations in real-time with optimal weapon system-target pairings. These weapon system-target pairings are available continuously and the system run times may be measured in seconds or even fractions of a second. The real-time speed is dependent on the size of the data set. For example, for a twenty weapon system pairing, the program provides outputs in about 1 second, for a 100×100 system, 10 seconds, and for a 300×300 system, a few minutes. Accepted pairing recommendations are saved in separate formats by weapons, targets, and threats and their statuses are updated. The end result are databases that continuously reflect the most current statuses of the weapons, targets, and threats in order of availability, recommended weapon system-target pairings and accepted weapon system-target pairings.

In one embodiment, the method manages weapon system-target pairings in real-time through an interface using an integer linear program solved by an open source optimization engine with data input through databases. The method is versatile and applicable to a large number of environments where weapon system-target pairings are required. For example, this method may be used during combat or non-combat operations by distributed battle management teams managing large volumes of strike aircraft, weapons, and targets, with team members located in an aircraft, remote tent, in a large fixed command center, or aboard a ship. A single device or multiple devices may run the system such as a typical computer, computer network, military computer system, Mac, PC, laptop, smartphone, iPhones, Blackberries, Android systems, Palm devices, netbooks, smartbooks, tablets, broadband devices, or the like.

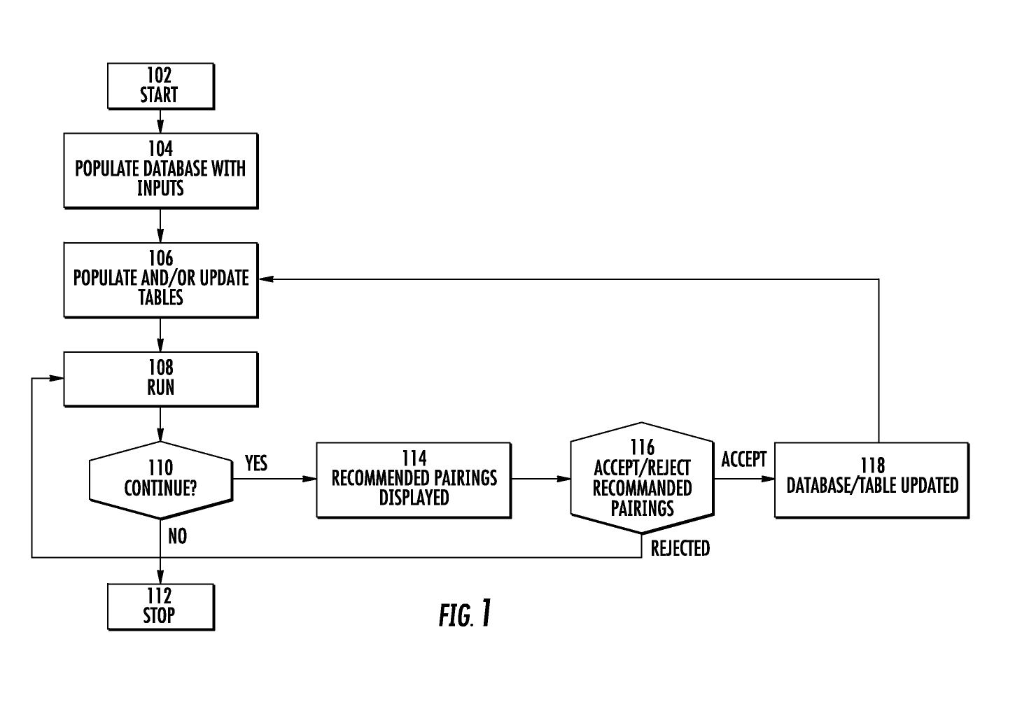

FIG. 1 is a flowchart for the method for weapon system-target pairing in real-time. The method 100 begins at step 102 by a user populating (step 104) and/or updating (106) databases such as available weapon or weapon systems, targets, and threats. These inputs are entered into a table, chart or graph format and at step 108, an optimization engine to solve a mathematical model using data from the table is run. At step 110, the user may decide to stop or to continue. If the user decides to stop, the process is stopped at step 112. If the user decides to continue, at step 114, recommended weapon system-target pairings are received from the optimization engine then displayed on a user interface. The user then has the option to accept or reject the recommended weapon system-target pairings at step 116. If pairings are accepted, at step 118, the databases or tables are updated with current statuses. The process then returns to step 104/106. If the pairings are rejected, the process is returned to step 108. This method occurs in real-time.

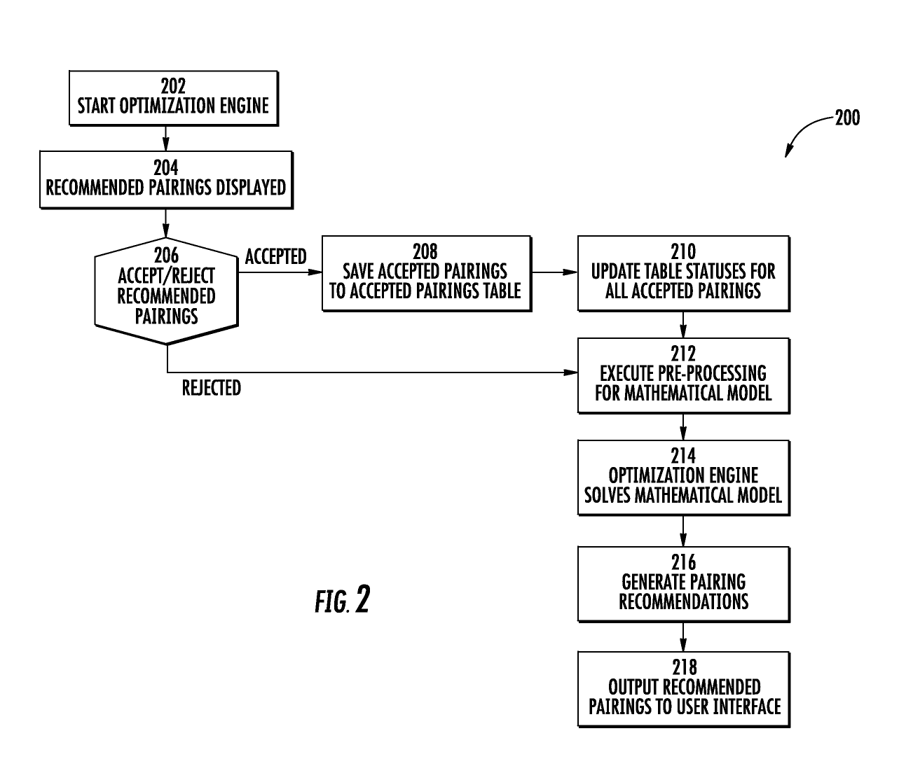

FIG. 2 depicts a flowchart of the run step 108 in FIG. 1. The process 200 starts at step 202 entering into an optimization engine to solve a mathematical model using data from the table. Recommended weapon system-target pairings are returned at step 204 and at step 206, the user has the option to accept or reject the pairings. If any pairings are accepted, they are saved to an accepted pairings table at step 208 and the databases are updated for all accepted pairings at step 210. At step 212, pre-processing for the mathematic model is executed. An optimization engine solves the mathematic model at step 214. At step 216, the pairing recommendations are generated. At step 218, the recommended pairings are output to the user's interface or device. The process continues on from this point as described in FIG. 1, step 110.

Referring back to FIG. 2, if no recommended pairings are accepted at step 206, the process goes directly to step 212 where pre-processing for the mathematical model solver is executed. The process then continues as described above with step 216 and 218.

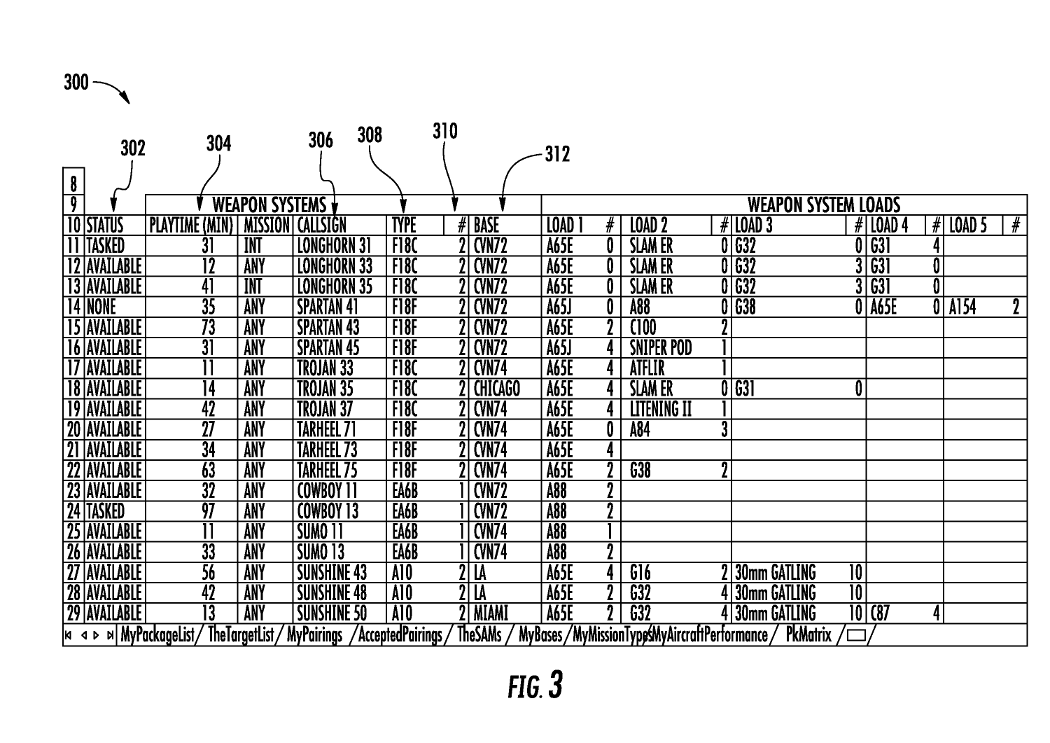

FIG. 3 illustrates an example of a weapon system table. The various columns describe available strike packages as well as available weapon loadouts.

In weapon system table 300, the weapon system data in column 302 includes the status or the real-time availability of the weapon system and whether it is available or has been tasked. Weapon system playtime or the time the weapon system can remain on station until it is no longer available for mission assignment is shown in column 304. The call sign or name of the individual weapon system is described in column 306, while columns 308 and 310 show weapon system information such as type and number of weapons respectively. The base or the current location of the weapon system is detailed in column 312.

In military parlance, a loadout is a combination of weapon systems carried by a generally larger weapon system for a mission. It describes the equipment the weapon system is “loaded out” with. For example, an aircraft might have a loadout made up of a camera pod, an electronic jamming pod, four air-to-ground missiles and two air-to-air missiles. The term “loadout” generally includes all the destructive and non-destructive weapon systems the aircraft is carrying for a specific mission. In one embodiment, the system may be used for planning purposes thus the loadouts are hypothetical in contrast to actual loadouts generally used for real-time operations. For example, a user may want to determine the best loadout for a weapon system to be composed of given a known set of targets and a known set of available loadouts. In that case, the user enters all the available loadouts, which may be much greater than what the weapon system could actually carry, and the method determines which of the available loadouts would produce the desired effects on the assigned target.

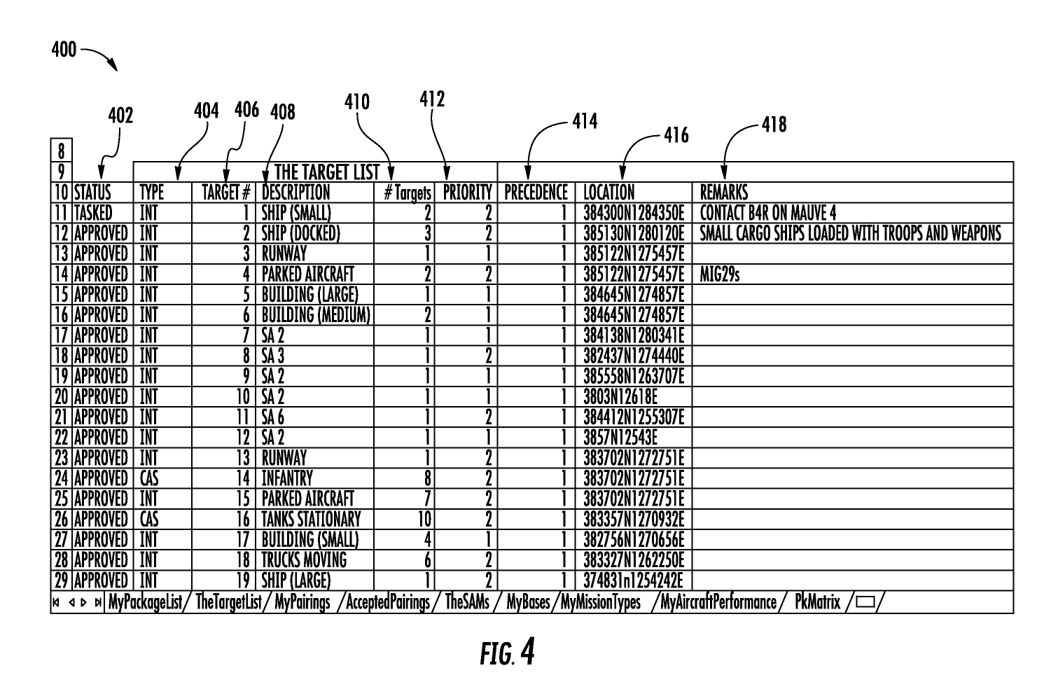

FIG. 4 describes an example of a target table. The various columns describe the target list. In target table 400, column 402 is target data which includes weapon system status such as approved or tasked. “Approved” means the target has been approved as a target by the appropriate commander and will be considered for a pairing while “tasked” means the target already has a weapon assigned to it. Column 404 is the type referring to the mission type of the target and column 406 assigns a number to the target. A description describes available target types in column 408. Column 410 is the number of targets being the number of targets that must be struck. A priority is the commander's priority setting assigned in column 412. Column 414 shows the precedence which is the requestor's precedence, while column 416, location, is the target location. Column 418 is available for any remarks.

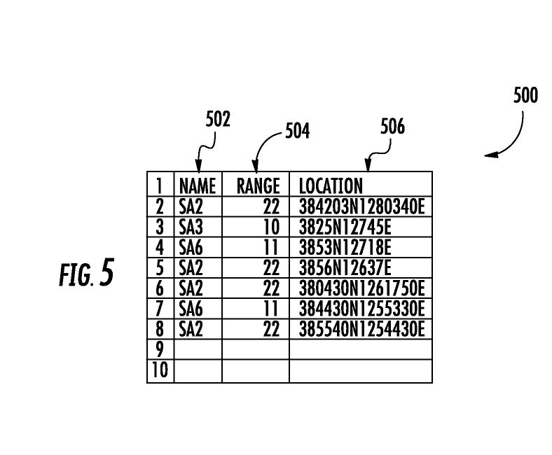

FIG. 5 discloses an example of a threats table. Referring to FIG. 5, the threats database or table 500 includes threat name (column 502), range in distance such as kilometers or meters (column 504) and location (column 506).

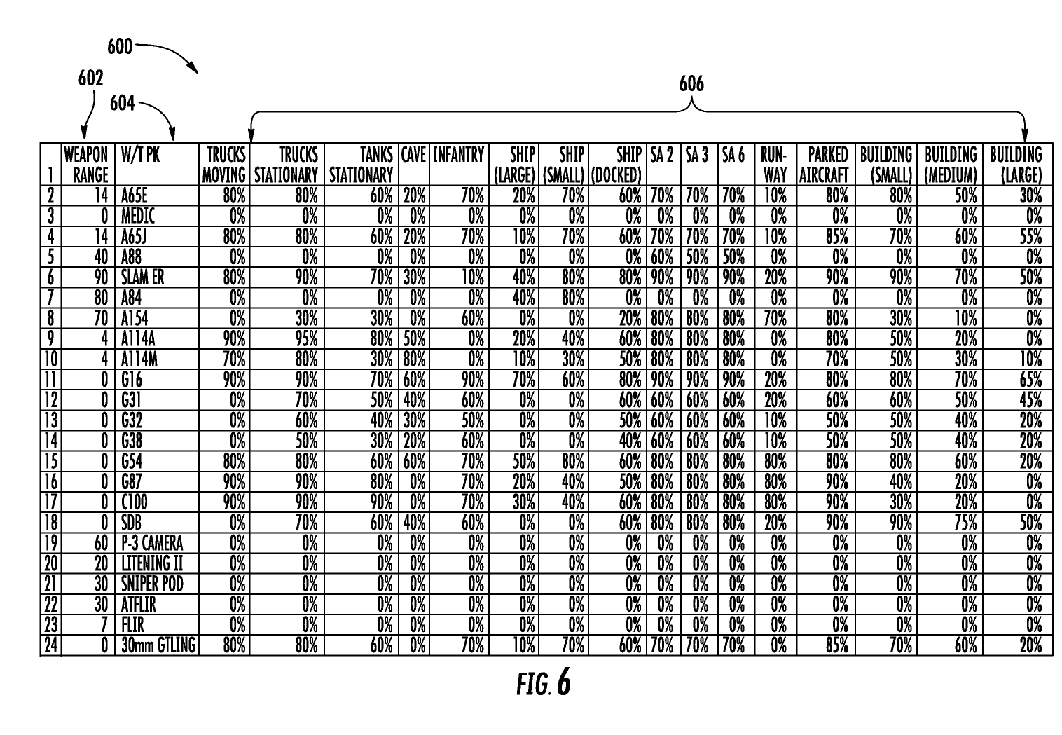

FIG. 6 depicts a weapon table which provides the individual weapons that may comprise the weapon systems in FIG. 3. A weapon system may be a simple weapon, for example, a gun or a missile, or a more complicated weapon system such as multiple aircraft equipped with multiple missiles, bombs, targeting systems, and guns, a submarine armed with missiles, torpedoes, mines, and detection devices, or a large integrated air defense system with radars, targeting systems, missiles, guns, and communication links. Weapon systems are often made up of a combination of destructive systems, such as guns and missiles, and/or non-destructive systems, for instance, cameras, radars, electronic sensors, jammers, communication systems and/or medical teams. For example, a helicopter (a weapon system) may be loaded with a camera, missiles, and a medical team, and may then be paired with different targets such as a truck, oil pipeline or field hospital.

This could be happening in real-time as targets emerge and target statuses change on the battlefield. For example, the helicopter may be assigned to use its camera to observe an assigned target and report its status. The same helicopter may be assigned to target a wounded soldier for medical evacuation using its onboard medical team. The helicopter may then be assigned to target enemy equipment with its missiles. The purpose of the pairing may be combative, non-combative or a combination thereof.

Referring to FIG. 6, the weapons table 600 is populated with each weapon available in the weapon system to include weapon name in column 604, range in column 602 and probability of success against various threats in the various columns designated as 606. In one embodiment, each weapon has specific probabilities of success for each target. For example, a SLAM ER missile has an 80% probability of success against trucks moving, a 30% probability of success against cave and 90% probability of success against building (small). Some columns in FIG. 6 link into FIG. 3. In further embodiments, other tables link data to one another.

In a non-limiting example, a battle management team utilizes the method for weapon system-target pairings. A first user of the team monitors the status of potential weapons or strike packages, such as aircrafts, ships, artillery, unmanned aerial vehicles, cruise missiles, naval gunfire and the like via radio communications and datalink. A second user of the team receives the status of targets via satellite communications (satcom). A third user of the team tracks threats such as surface to air missiles, hostile aircraft, enemy ground forces or the like also via satellite communications. Simultaneously, in some embodiments, a fourth user of the team or the team leader, operates the system by manually entering available aircraft strike package statuses, target statuses, and threat statuses in a spreadsheet style table as depicted in FIGS. 3, 4 and 5 respectively. The first, second, third and fourth users may be the same person or multiple people.

The databases may use drop down menus or pre-populated drop down menus. This allows for rapid status selection thus speeding up data entry and preventing users from making typing errors. For example, drop down menus are used in FIG. 3 allowing the option to select any type of weapon system available. In one embodiment, data and voice communications bearers may be utilized allowing databases and tables to be populated and updated by voice providing a hands-free environment.

Pre-processing the inputs in the various tables described above to create formatted data within the tables for the optimization engine to solve a mathematical model is automatically executed in the method. All of the inputs in the various databases or tables are transformed into a format that the optimization engine can use. In one embodiment, several of the databases with calculations are cleared and column labels are printed on some of the cleared databases. Remaining playtime for each strike package is calculated while loadouts, aircraft types, base names and targets, for example, are hashed out to allow for rapid search later. Aircraft combat radiuses may be paired based on aircraft type selected. A distance matrix is calculated showing the distance between each weapon system and each target. The required weapon standoff based on the threats for each target is calculated and the reward value for each feasible pairing is calculated. Optimization engine inputs are finalized.

The mathematical model is populated automatically and the optimization engine is run. The optimization engine evaluates the inputs, chooses the best or fastest algorithm to solve the mathematical model, then applies the algorithm to the populated model and provides, as an output, the optimal weapon system-target pairs.

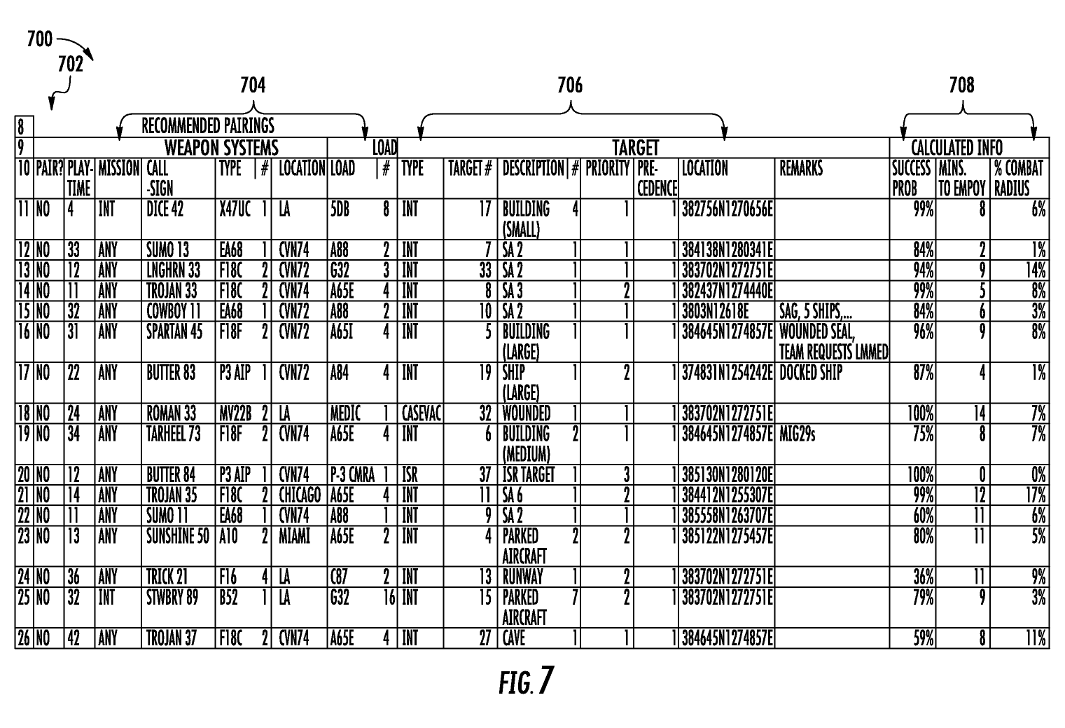

The method may be executed at any time to produce optimal recommended weapon system-target pairings quickly, in real-time as illustrated in FIG. 7. Real-time is a time period less than one minute, less than 30 seconds, or less than ten seconds. The populating, entering, running, receiving and displaying are capable of occurring in less than 1 second.

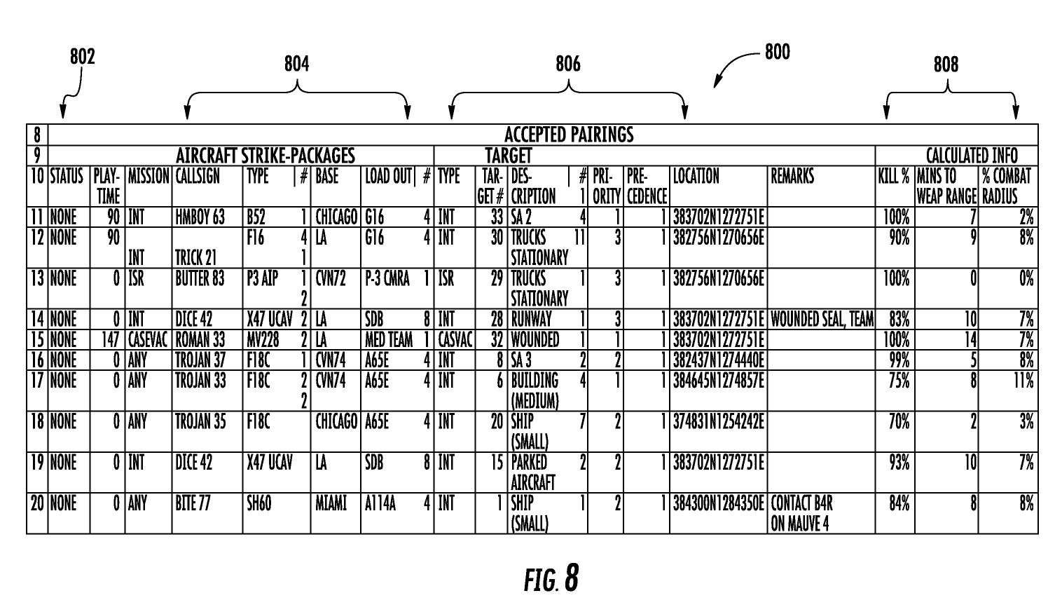

Referring to FIG. 7, the recommended weapon system-target pairings are displayed on the user interface in order from the pairing with highest reward value to the pairing with the lowest reward value. These may be accepted or rejected individually by a user thus additional user input for accepting or rejecting the weapon system-target pairing recommendations is received. Column 702 shows the status of yes/no as to whether the recommended weapon system-target pairings are accepted. In one embodiment, pre-populated drop down menus are used to select yes or no. If yes is selected, the recommended weapon system-target pairings is accepted and automatically added to the running tally of accepted pairings in another table such as FIG. 8 (described below), then this additional user input is updated and displayed in the recommended pairings table on the user interface. All accepted pairings are continuously tracked throughout the mission.

The several columns within 704 and 706 list the weapon and target information respectively. The columns within 708 detail the calculated information such as success percentage, minutes to target and percent of combat radius. These values change each time the program is run and also link into other tables.

Once a recommended pairing is accepted in FIG. 7, the accepted pairing links into and appears in FIG. 8, the accepted pairings table. Each of the accepted pairings appears in the next empty or available row in FIG. 8. For example, if the first six rows of the accepted pairings table list the accepted pairings, row seven will be filled with the next accepted pairing then row eight.

Referring to FIG. 8, the accepted weapon system-target pairings are displayed. Column 802 shows the status of the accepted weapon system-target pairings. All accepted pairings are continuously tracked throughout the mission. As in FIG. 7, the several columns within 804 and 806 list the weapon and target information respectively. The columns within 808 detail the calculated information such as success percentage, minutes to target and percent of combat radius.

The statuses of all tables affected by an accepted recommended pairing are updated after a recommended pairing is accepted. For example, corresponding strike package statuses, target statuses and threat statuses, FIGS. 3, 4 and 5 respectively, are automatically updated thus linking the tables together. The status for each accepted weapon system and target is automatically updated to “tasked” status in the weapon system table (FIG. 3) and target table (FIG. 4). In this way, when the optimization engine to solve a mathematical model is run, “tasked” weapon systems and targets will not be considered for pairing. In the case of weapon systems, the weapon system is already busy executing the assigned mission and cannot accept any other tasking. For targets, if a weapon or weapon system is already assigned to a target, it cannot be considered as available. The user also has the option to update the tables with new, changed, or additional information.

In one embodiment, the battle management team is networked together thus each user in their particular environment such as in an aircraft, tent, ship, or the like may continuously input information manually or automatically into the databases via data link, chat, internet, satellite communications, or the like without interruption. Furthermore, the user can access data of concern as opposed to all of the data. For example, the user responsible for assigning strike aircraft does not necessarily need to be view the status of targets. In this way, the user is more efficient with the task at hand.

A user of the team may access the automatically generated information in the accepted pairings table in FIG. 8 to communicate instructions to, for example, strike aircraft or ground troops, via radio and/or data link while other users continue to manage strike package, target, and threat statuses. The result is optimal recommended pairings in real-time while strike packages, targets, and threat statuses are maintained in real-time.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

1. A method for real-time pairing of weapon systems with targets, the method including:
(i) populating a database with inputs, the inputs in the database include available weapon systems, targets, and threats;
(ii) entering the inputs into a table;
(iii) pre-processing the inputs in the table to create formatted data within the table;
(iv) running an optimization engine to solve a mathematical model using the formatted data from the table;
(v) receiving weapon system-target pairing recommendations from the optimization engine; and
(vi) displaying the weapon system-target pairing recommendations on a user interface;
wherein the populating, entering, pre-processing, running, receiving and displaying are performed in real-time.

2. The method of claim 1, wherein real-time is a time period less than 1 minute.

3. The method of claim 1, wherein real-time is a time period less than 30 seconds.

4. The method of claim 1, wherein real-time is a time period less than 10 seconds.

5. The method of claim 1, wherein the populating, entering, pre-processing, running, receiving and displaying are capable of occurring in less than 1 second.

6. The method of claim 1, further comprising:
(vii) receiving additional user input for accepting or rejecting the weapon system-target pairing recommendations;
(viii) updating the weapon system-target pairing recommendations based on the additional user input for accepted and rejected recommended weapon system-target pairings; and
(ix) displaying the updated weapon-target pairing recommendations on the user interface.

7. The method of claim 1, wherein each weapon has specific probabilities of success.

8. The method of claim 1, wherein the database is arranged in a table, chart or graph format.

9. The method of claim 8, wherein the database is displayed in order of available weapon systems, targets, and threats in separate formats.

10. The method of claim 1, wherein the populating the database is accomplished by drop down menus.

11. The method of claim 1, wherein the populating the database is accomplished by pre-populated drop down menus.

12. The method of claim 1, wherein the populating the database occurs over a satellite, internet or radio network.

13. The method of claim 1, wherein the inputs are provided by a user.

14. The method of claim 8, wherein the table, chart or graph are linked to another table, chart or graph.

15. The method of claim 6, wherein the recommended weapon system-target pairings are displayed on the user interface in order from a pairing with highest reward value to a pairing with the lowest reward value.

16. A method for real-time pairing of weapon systems with targets, the method including:
(i) populating a database with inputs, the inputs in the database include available weapon systems, targets, and threats;
(iii) pre-processing the inputs to create formatted data;
(iv) running an optimization engine to solve a mathematical model using the formatted data;
(v) receiving weapon system-target pairing recommendations from the optimization engine; and
(vi) displaying the weapon system-target pairing recommendations on a user interface;
wherein the populating, pre-processing, running, receiving and displaying are performed in real-time.

17. The method of claim 16, wherein real-time is a time period less than 30 seconds.

18. The method of claim 16, wherein real-time is a time period less than 10 seconds.

19. The method of claim 16, wherein the populating, entering, pre-processing, running, receiving and displaying are capable of occurring in less than 1 second.

20. The method of claim 16, further comprising:
(vi) receiving additional user input for accepting or rejecting the weapon system-target pairing recommendations;
(vii) updating the weapon system-target pairing recommendations based on the additional user input for accepted and rejected recommended weapon system-target pairings; and
(viii) displaying the updated weapon-target pairing recommendations on the user interface.
